(19) United States
(12) Patent Application Publication
(10) Pub. No.: US 2013/0303039 A1
(43) Pub. Date: Nov. 14, 2013

(54) Top sheet with integrated graphics

(71) Applicant: Tony Logosz, Hood River, OR (US)

(72) Inventor: Tony Logosz, Hood River, OR (US)

(21) Appl. No.: 13/506,704

(22) Filed: May 10, 2012

(51) Int. Cl. B63B 35/79; B32B 3/10; B44C 1/16; B32B 38/10

(52) U.S. Cl. 441/74; 156/247; 428/195.1

(57) ABSTRACT

The disclosure is directed to laminated structures and methods of producing such structures having a top sheet with integrated graphics. The top sheet is formed by applying an uncured polymeric resin to a substrate and placing a film having a transferable image on the top sheet. The image sublimates into the top sheet and the film may be removed after the resin is cured. Optionally, a colorant may be added to the uncured polymeric resin to provide a uniform tint or a colorant may be selectively added to the uncured polymeric resin to provide a design in the uncured resin applied to the substrate. In one aspect, the laminated structure is a kite board or a wake board.

### FIELD OF THE PRESENT INVENTION

The present invention relates generally to the construction of structures having a polymeric top layer having an integrated graphic design and more particularly to laminated structures used for recreation such as kite boards and wake boards.

### BACKGROUND OF THE INVENTION

Kite boards, wake boards, skis, surf boards, snow boards, skate boards and the similar recreational devices often exhibit a laminated construction in which a top sheet is applied over a substrate having desired structural characteristics suited to the particular application. It is desirable to adapt the construction of such articles so as to permit or enhance graphical elements. For example, boards used for these types of recreational pursuits often have dramatic decorative schemes to improve their aesthetic appeal and to increase the desirability for the user. In addition to the ornamental aspects, the graphical elements can also contain information, advertising, specifications, or be used in the recommended configuration of the board such as by indicating preferred binding or strap placement. Further, although discussed with reference to recreational device, the laminated or molded construction techniques discussed herein are used in a wide variety of applications.

Typically, the overall mechanical properties of a laminated recreational device are established in the configuration and choice of materials that form the interior layers of the device. For example, the core of such devices is often made of wood, foam and/or metal materials and may then be wrapped in one or more layers of composite materials, such as fiberglass or carbon impregnated with a suitable resin, such as polyester or epoxy. The top sheet can then be laminated to the core to complete the construction. While the top sheet may or may not have a substantial effect on the performance characteristics of the device, it nevertheless serves several critical functions. Preferably, the top sheet is resilient with high abrasion and cut resistance to protect the interior structural components of the device from wear and impact. Also preferably, the top sheet is water proof to help prevent degradation of the core materials. Furthermore, with particular relevance to this disclosure, the top sheet establishes the type and quality of graphics that can be used on the device.

One prior art technique for adding graphics to the top sheet of a laminated recreational device include involves applying the graphics directly to the top surface of the device. This technique lends great flexibility in that any suitable method of applying graphics can be used, including silk screening, painting and lithography. However, since the graphics are exposed on the outer surface of the top sheet, they are very vulnerable to wear and environmental degradation. Further, the graphics often involve a separate manufacturing step following lamination of the top sheet to the device, complicating the process.

To overcome some of the limitations discussed above, attempts have been made to incorporate the graphics directly into the top sheet. As will be recognized, this approach can mitigate some of the problems associated with techniques involving graphics applied to the surface of the top sheet. However, there are logistical consequences associated with integrating the graphics into the top sheet. Notably, it is desirable to be able to adapt the style and content of the graphics as rapidly as possible to accommodate shifting trends and tastes. This goal is hindered by the need to manufacture the top sheet with integrated graphics prior to the overall assembly of the recreation device, as the graphics must be established at an earlier stage of the process. Similarly, supply issues are complicated as the use of integrated graphics requires a sufficient stock of top sheets having the desired characteristics and images to avoid interruptions in the manufacturing process.

Accordingly, what has been needed is a technique for providing graphics in a laminated or molded device that avoids the need prepare a top sheet with integrated graphics as a separate step in the manufacturing process. There also a demand for graphics that are more durable and easier to produce than those applied to the surface of a top sheet. This invention satisfies these and other needs.

### SUMMARY OF THE INVENTION

In accordance with the above objects and those that will be mentioned and will become apparent below, the present invention is a method for producing a laminated structure having integrated graphics comprising providing a substrate, applying an uncured polymeric resin to the substrate to form a top sheet, layering a film having a transferable image on the top sheet, sublimating the image into the top sheet, curing the resin and removing the film. Optionally, a colorant may be added to the uncured polymeric resin to provide a uniform tint or a colorant may be selectively added to the uncured polymeric resin to provide a design in the uncured resin applied to the substrate.

In some embodiments, the substrate comprises a core and a layer of reinforcing material. Preferably, the uncured polymeric resin forms a matrix with the reinforcing material. A presently preferred polymeric resin is a polyurethane.

In one aspect, the laminated structure comprises a kite board or a wake board.

This disclosure is also directed to a laminated structure comprising a substrate and a top sheet of cured polymeric resin, wherein the top sheet has integrated graphics formed by applying a film with a transferable image to the polymeric resin before curing so that at least part of the image sublimates into the top sheet. Preferably, the laminated structure is a kite board or a wake board and the substrate is a core and a layer of reinforcing material.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a cross sectional view of a laminated device having sublimated graphics during manufacture, according to the invention.

### DETAILED DESCRIPTION OF THE INVENTION

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a,” “an” and “the” include plural referents unless the content clearly dictates otherwise.

The systems and methods for producing a laminated device having sublimated graphics in a layer of the construction. As will be described below, the graphics may be incorporated easily during the manufacturing process and does not require any separate steps. An important aspect of these techniques is the concept of transferring a desired graphics image by way of a transfer film to an uncured polymeric resin. The polymeric resin is then cured during the manufacturing process, resulting in a laminated device having at least one layer comprising the cured resin with transferred graphics.

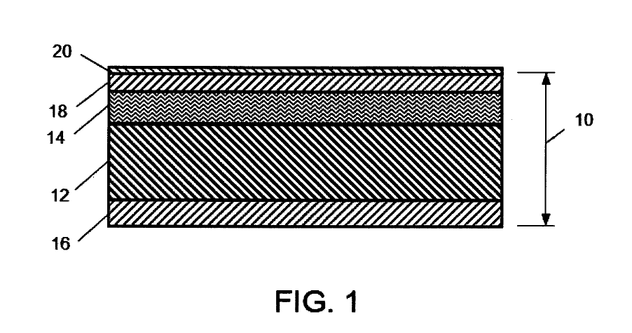

Further details regarding these aspects of the disclosure are discussed below regarding a layup used to manufacture a kite board 10 as shown in FIG. 1 as an illustrative example. The following techniques may be applied in a similar manner to other types of recreational devices including wake boards, surf boards, skis, snow boards and the like, as well as to more general applications to any suitable substrate. The layers shown in FIG. 1 are not necessarily to scale, but depict the general orientation of the elements. In this embodiment, the kite board 10 includes a core 12, a reinforcing layer 14, a bottom sheet 16 and a top sheet 18. Top sheet is formed from a polymeric resin that is applied in liquid form and then cured during the manufacturing process. The graphics are integrated into top sheet 18 through the use of transfer film 20, which is applied to top sheet 18 prior to the curing of the polymeric resin. Preferably, the respective layers are placed in a press, mold, vacuum bag or other suitable clamping apparatus configured to impart a uniform pressure and heat to the layers to facilitate the curing of the polymeric resin. Following the curing step, the transfer film 20 is peeled off after the kite board 10 is removed from the press.

During the curing process, graphics applied to transfer film 20 sublimate into the polymeric resin. As will be appreciated, a wide range of techniques can be used to create virtually any desired image on transfer film 20. In a preferred example, an ink jet printer or other digital printmaking technique may be used to reproduce a digitized image on transfer film 20. However, any other suitable technique may easily be employed, including silk screening, lithography, serigraphy and the like. Mechanized techniques such as these offer the advantages of being quick and cost-effective, and are generally suitable for producing multiple copies or versions of particular design. Alternatively, any suitable manual technique may also be employed, allowing the creation of unique images. In general, the only constraint on the graphics as applied to transfer film 20 is that the ink, paint, dye, pigment or other colorant is compatible with the polymeric resin so as to achieve the desired degree of sublimation. Preferably, film 20 may be a polyethylene or any other suitable material.

In another aspect, the graphic image imparted into top sheet 18 may also include coloration of the liquid polymeric resin, either before or after is applied to the reinforcing layer 14. For example, a suitable colorant may be blended into the polymeric resin before application to create a uniform tint. Colorant may also be selectively added once the polymeric resin is spread onto reinforcing layer 14, using a brush, spray apparatus, dropper, or any other suitable applicator. As will be appreciated, adding colorant after the polymeric resin is applied allows for varying designs ranging from representational to abstract to be integrated into top sheet 18. To the extent these applications are performed manually, a high degree of customization may be achieved as desired.

Either or both of the techniques of transferring an image using film 20 and adding colorant directly to the uncured polymeric resin, highly distinctive effects may be achieved enhancing the aesthetic aspects of the graphics produced. As will be appreciated, the cured polymeric resin may have a range of opacities, ranging from clear to semi-transparent to opaque. This quality provides an element of depth to the resulting images. In one example, by employing a relatively transparent polymeric resin, the substrate formed by core 12 and reinforcing material 14 can be made visible through top sheet 20, adding to the overall image that is visible when kite board 10 is viewed from the top. Indeed, the configuration of the substrate may be chosen to enhance the visual effect and may include the addition of further graphic elements, printed or otherwise, under top sheet 20.

Further, since the graphic is integrated into the polymeric resin of top sheet 20, the image is significantly resistant to damage and degradation. The graphics will not flake or peel off and surface scratches will have little effect. The polymeric resin may also be imparted with other protective properties, such as being UV resistant, absorbing or blocking to inhibit fading of the sublimated graphics.

The construction of kite board 10 preferably employs techniques and materials as known in the art. Core 12 is generally formed from a structural material, such as wood, metal, foam or other polymeric materials. Wood is a particularly preferred material due to its beneficial structural properties and ready machineability. The layer of reinforcing material 14 is typically added to augment the structural characteristics of the core material. In other applications, the reinforcing material may be omitted and the top sheet formed directed on a substrate. Preferred materials include filamented compositions having a plurality of fibers embedded in a suitable matrix such as fiber glass or carbon fiber and the like. More preferably, the reinforcing materials have an oriented-strand configuration. As desired, the reinforcing material may be uni-directional or multi-directional to achieve different structural properties and may comprise woven sheets, meshes or mats. Bottom sheet 16 is generally chosen for its properties and may comprise a polymeric material bonded to the core through the use of a separate adhesive or by the same polymeric resin used to form top sheet 20. An additional layer of reinforcing material may be provided between core 12 and bottom sheet 16 as desired.

As known in the art, the reinforcing material is preferably embedded in a matrix to achieve a composite structure, such as epoxy, thermosetting polymers or thermoplastics. To facilitate manufacture, the same polymeric resin as used to form top sheet 20 may be employed. Sufficient polymeric resin is added to thoroughly wet, embed, and otherwise saturate the reinforcing material and form a top sheet of the desired thickness. Alternatively, a different resin may be used in a separate manufacturing step. Presently preferred polymeric resins include polyurethanes, polyesters, and epoxies. The curing process may be tailored to the specific resin used, but generally includes subjecting the laminated article to heat and pressure to uniformly distribute the polymeric resin throughout the desired area, displace any entrapped air or other voids, and achieve a full cure. For example, in one embodiment, a polyurethane resin is used and is cured at a temperature of approximately 145° C. for approximately 30 minutes.

Although described in the context of kite board 10, the techniques of this disclosure may be broadly applied to virtually any article that includes a visible layer formed by polymeric resin. Such article may be substantially laminate in nature, such as kite board 10, in which the polymeric resin layer forms either or both the top and bottom surfaces, or may represent a more complex, three-dimensional structure have a coating formed by the polymeric resin. In its broadest aspect, this disclosure is directed to the use of a polymeric resin having sublimated graphics transferred from a film.

In the embodiments discussed above, the uncured polymeric resin is applied to the substrate and film 20 is used to transfer any graphic image carried by the film to the resin. Alternatively, the polymeric resin may be floated on top of film 20 and at least partially cured to allow a top sheet to be formed prior to being laminated to a substrate. One aspect of this technique is that it allows the production of a top sheet having a reduced thickness. The polymeric resin is applied and receives the graphics from the transfer film at a first thickness. Then, after being at least partially cured, the top sheet is released from the transfer film and stretched until one or more areas have a reduced thickness. In this manner, a relatively thin top sheet can be more easily formed than through the use of conventional techniques. The transferred graphic image is preferable configured to accommodate the anticipated degree of stretching. Alternatively, distinctive visual effects may be achieved by selectively stretching portions of the top sheet.

Described herein are presently preferred embodiments, however, one skilled in the art that pertains to the present invention will understand that there are equivalent alternative embodiments. As such, changes and modifications are properly, equitably, and intended to be, within the full range of equivalence of the following claims.

What is claimed is:

1. A method for producing a laminated structure having integrated graphics comprising providing a substrate, applying an uncured polymeric resin to the substrate to form a top sheet, layering a film having a transferable image on the top sheet, sublimating the image into the top sheet, curing the resin and removing the film.

2. The method of claim 1, further comprising the step of adding a colorant to the uncured polymeric resin to provide a uniform tint.

3. The method of claim 1, further comprising the step of selectively adding a colorant to the uncured polymeric resin to provide a design in the uncured resin applied to the substrate.

4. The method of claim 2, further comprising the step of selectively adding a colorant to the uncured polymeric resin to provide a design in the uncured resin applied to the substrate.

5. The method of claim 1, wherein the substrate comprises a core and a layer of reinforcing material.

6. The method of claim 5, wherein the uncured polymeric resin forms a matrix with the reinforcing material.

7. The method of claim 6, wherein the uncured polymeric resin is a polyurethane.

8. The method of claim 5, wherein the laminated structure comprises a kite board.

9. The method of claim 5, wherein the laminated structure comprises a wake board.

10. A laminated structure comprising a substrate and a top sheet of cured polymeric resin, wherein the top sheet has integrated graphics formed by applying a film with a transferable image to the polymeric resin before curing so that at least part of the image sublimates into the top sheet.

11. The laminated structure of claim 10, wherein the laminated structure comprises a kite board and wherein the substrate comprises a core and a layer of reinforcing material.

12. The laminated structure of claim 10, wherein the laminated structure comprises a wake board and wherein the substrate comprises a core and a layer of reinforcing material.
